(19) United States
(12) Patent Application Publication
(10) Pub. No.: US 2008/0125171 A1
(43) Pub. Date: May 29, 2008

(54) PORTABLE TERMINAL WITH PROTRUSION TYPE MIC MODULE

(75) Inventor: Ok-Jo Shin, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/941,653

(22) Filed: Nov. 16, 2007

(30) Foreign Application Priority Data
Nov. 23, 2006 (KR) 2006-0116169

(51) Int. Cl. H04M 1/00

(52) U.S. Cl. 455/556.1

(57) ABSTRACT

Provided is a portable terminal with a protrusion type mic module. The portable terminal includes a camera module installed at a predetermined portion of the portable terminal, and a mic module selectively protruding from the portable terminal according to user's manipulation, the mic module for audio recording.

### PRIORITY

This application claims priority under 35 U.S.C. § 119 to an application filed in the Korean Intellectual Property Office on Nov. 23, 2006 and assigned Serial No. 2006-116169, the contents of which are incorporated herein by reference.

### BACKGROUND OF THE INVENTION

1. Field of the Invention

The present invention relates generally to a portable terminal including a microphone (mic) module for capturing a moving image, and in particular, to a portable terminal with a protrusion type mic module that selectively protrudes from the terminal in capturing a moving image thus to contribute to refining an exterior of a device, and allows voice/sound recording in a desired direction.

2. Description of the Related Art

As portable terminals are becoming more and more popular, terminal providers are making efforts to provide smaller and slimmer portable terminals with various functions in order to meet consumers' demands. Particularly, the portable terminal is required to have a smaller volume while still performing functions of fundamental components of the terminal, such as a display unit, a speakerphone unit, and a microphone unit.

Also, additional components are being added to the portable terminal so that the terminal can provide other functions besides a basic voice-communication function. For example, a user can receive a general public broadcasting service by using a portable terminal including a Digital Multimedia Broadcasting (DMB) module, can download and listen to music by using a portable terminal including an MP3 player, or can capture a still image or a moving image by using a portable terminal including a camera module.

To capture a moving image using the portable terminal including the camera module, the portable terminal includes a separate directional microphone unit for recording, besides a microphone that is a fundamental component of the portable terminal. In a conventional portable terminal, a directional microphone unit is installed near the camera module, and sound-reception holes for receiving an external voice/sound are respectively formed at front and rear sides of a case frame of the portable terminal where the microphone unit is installed, which makes a manufacturing process complicated. Also, since the receiving holes are installed in the case frame, oriented only to a predetermined direction, it is difficult to record a desired volume/sound in a desired direction.

### SUMMARY OF THE INVENTION

An aspect of the present invention is to substantially solve at least the above problems and/or disadvantages and to provide at least the advantages below. Accordingly, an aspect of the present invention is to provide a portable terminal with a protrusion type mic module that contributes to refining an exterior of the portable terminal.

Another aspect of the present invention is to provide a portable terminal with a protrusion type mic module that protrudes outside the portable terminal when a moving image is captured, and records a peripheral voice/sound, thereby improving performance of a device.

Still another aspect of the present invention is to provide a portable terminal with a protrusion type mic module that protrudes outside the portable terminal to record a voice/sound in a desired direction.

Further another aspect of the present invention is to provide a portable terminal with a protrusion type mic module that protrudes by simple manipulation so as to effectively record a peripheral voice/sound while an image of a desired object is captured, thereby improving user's convenience.

According to one aspect of the present invention, a portable terminal with a protrusion type mic module includes a camera module installed at a predetermined portion of the portable terminal and used to capture a still image and a moving image, and a mic module selectively protruding from the portable terminal according to user's manipulation, the mic module recording a voice/sound when a moving image is captured with the camera module.

According to another aspect of the present invention, the mic module includes a rotatable mic tip at an end portion of the mic module. The mic tip includes sound reception holes in one surface and an other surface, respectively, so that a user can rotate the mic tip in a desired direction, and thus can effectively record a desired sound/voice.

According to still another aspect of the present invention, when the mic module is not used, the mic module and the mic tip are received in the terminal, so that the mic module does not damage an exterior and obviates inconvenient terminal manipulation.

According to further another aspect of the present invention, the mic module operates semi-automatically. Therefore, a pressing unit for pressing the mic module and a locking unit for selectively locking the mic module are provided. A torsion spring may be used as the pressing unit, and a hook-type lever operating inside the terminal in a simple manner may be used as the locking unit.

### BRIEF DESCRIPTION OF THE DRAWINGS

The above and other objects, features and advantages of the present invention will become more apparent from the following detailed description when taken in conjunction with the accompanying drawings in which:

FIG. 1 is a front perspective view of a portable terminal according to the present invention;

FIG. 2 is a rear perspective view of a portable terminal according to the present invention;

FIG. 3 is a front perspective view of a portable terminal, illustrating a protruding state of a mic module according to an embodiment of the present invention;

FIG. 4 is an exploded perspective view of a mic module according to the present invention;

FIGS. 5A and 5B illustrate an operation of a mic tip of a mic module according to the present invention;

FIG. 6 is a perspective view of a portion of a mic module that is fixed to a terminal according to the present invention;

FIGS. 7A and 7B illustrate an operation of a mic module according to the present invention;

FIG. 8 is a sectional view illustrating a locking unit of a mic module according to the present invention; and

FIG. 9 is a front perspective view of a portable terminal with a mic module according to another embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Although a pop-up type terminal, and a mic module applied to the terminal are described in the drawings, the present invention is not limited thereto. For example, the present invention is applicable to various types of terminals including a camera module for capturing an object, and a directional microphone for recording a voice/sound related to the capturing.

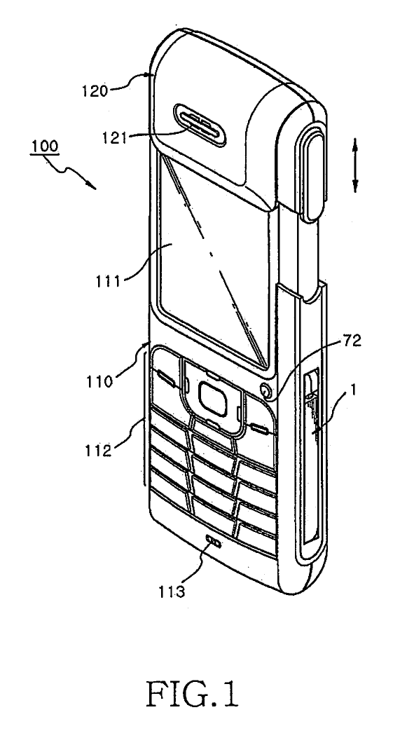

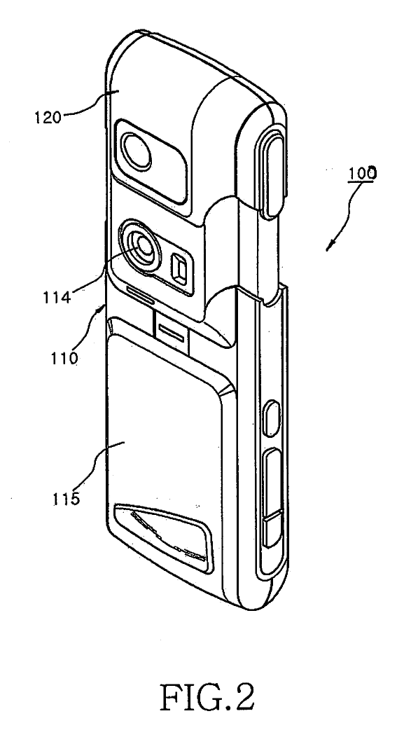

Referring to FIG. 1, the portable terminal 100 includes a main body 110 and a pop-up body 120 sliding on the main body 110 in a length direction of the portable terminal 100. As illustrated in FIG. 2, the pop-up body 120 may serve to protect a lens part of a camera module 114 installed at a rear side of the portable terminal 100 when the pop-up body 120 is closed.

The main body 110 includes a display unit 111 installed at an upper portion, and a keypad assembly 112 installed under the display unit 111 and including a plurality of key buttons, that is, a data input unit. The key buttons may include number key buttons, navigation key buttons, and various function key buttons. A communication mic unit 113 is installed under the keypad assembly 112.

The pop-up body 120 is installed to cover a portion of an upper part of the display unit 110 depending on an opening/closing operation, and includes a speaker unit 121 for communication. The speaker unit 121 is electrically connected to the main body 110 inside the terminal 100.

A mic module 1 is installed at one side of the main body 110. The mic module 1 is installed separately from the communication mic unit 113. The mic module 1 is used to record a peripheral voice/sound when a moving image is captured using the portable terminal 100. The mic module 1 may semi-automatically protrude outside the terminal by a mic button 72 installed at a predetermined portion of a front surface of the terminal main body 110.

FIG. 2 is a rear perspective view of the portable terminal 100 according to the present invention. The main body 110 includes a camera module 114 at its rear surface. The camera module 114 is used to capture, for example, a still image and a moving image. Also, a rechargeable battery pack 115 is installed at the rear surface of the main body 110, and is used as a power supply unit of the portable terminal 100.

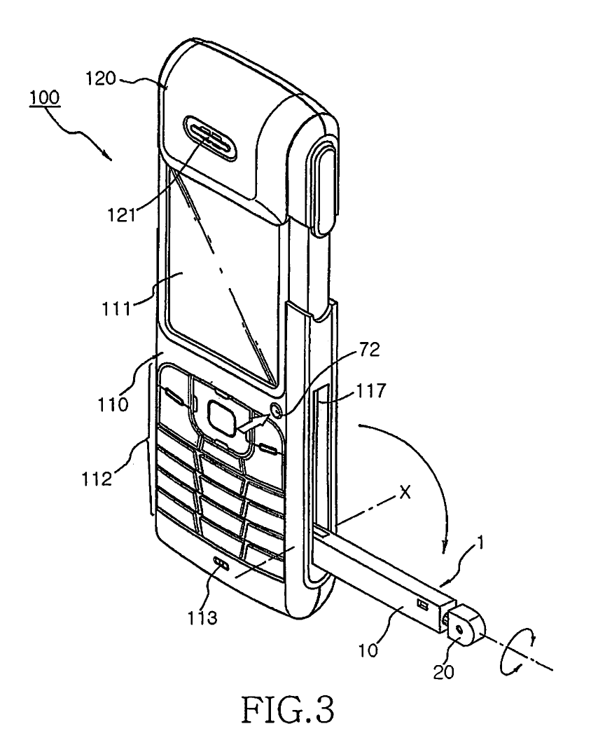

FIG. 3 is a front perspective view of the portable terminal 100, illustrating a protruding state of the mic module 1 according to an embodiment of the present invention. When a user presses the mic button 72, the mic module 1 installed at one side of the terminal 100 protrudes. The mic module 1 includes a protrusion arm 10 having a predetermined length, and a mic tip 20 installed at one end of the protrusion arm 10 and including a directional microphone. The protrusion arm 10 protrudes, pivoting on the other end of the protrusion arm 10, which is located at one side of the terminal 100. The protrusion arm 10 protrudes about a pivot axis X (see FIG. 3) perpendicular to a top surface of the portable terminal 100. In more detail, when not used, the mic module 1 is received in a mounting groove 117 formed in one side of the terminal 100. Thus, normally, the mic module 1 does not protrude from the portable terminal 10, so that an exterior of the portable terminal 100 is not aesthetically degraded.

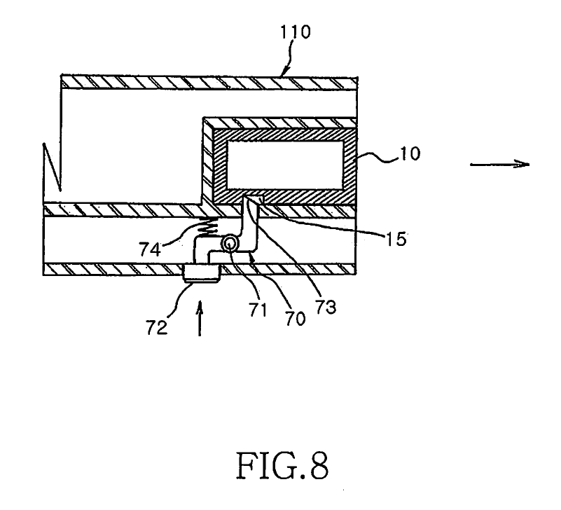

To capture an object using the camera module 114, a user presses the mic button 72 protruding from a front surface of the portable terminal 100. When the mic button 72 is pressed, as illustrated in FIG. 3, the mic module 1 protrudes from one side of the terminal 100. When the user does not use a moving-image capturing function, the mic module 1 is forced into the mounting groove 117 formed in one side of the terminal, and is fixed by a predetermined locking unit (see FIG. 8) as illustrated in FIG. 1.

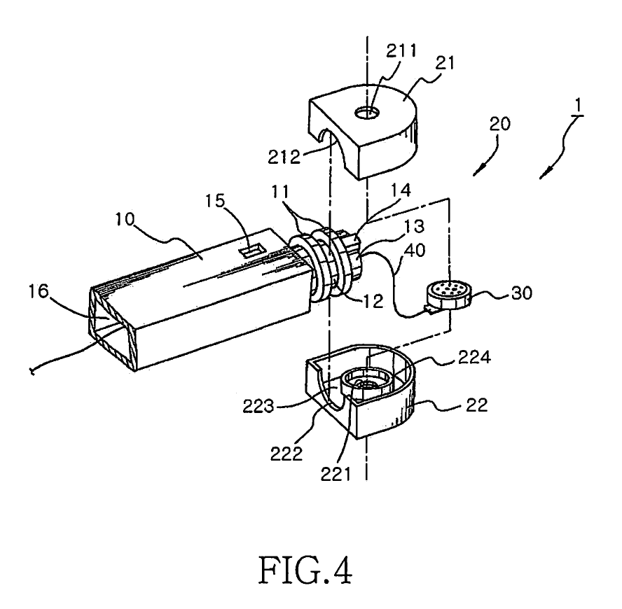

FIG. 4 is an exploded perspective view of the mic module 1 according to the present invention. The mic module 1 includes the protrusion arm 10 having a predetermined length, and the mic tip 20 installed at one end of the protrusion arm 10 and including a microphone 30. The mic tip 20 may be rotatably installed at the protrusion arm 10.

The protrusion arm 10 may be formed of a synthetic resin by a fabrication process such as injection-molding. The protrusion arm 10 may include a hollow space 16 through which a cable 40 from the microphone 30 extends to the main body 110 of the portable terminal 100. An end portion of the protrusion arm 10 to which the mic tip 20 is fixed is formed as a circular shaft shape, and a pair of stopping pieces 11 having the same diameter are formed on the end portion of the protrusion arm 10, spaced apart from each other. Thus, an insertion groove 12 is naturally formed between the protrusion pieces 11.

The mic tip 20 includes an upper case frame 21 and a lower case frame 22 that are coupled to each other. Recesses 212 and 222 are formed in the upper and lower case frames 21 and 22, and are fitted into the insertion groove 12 from the upside and from the downside, respectively, thereby rotatably installing the mic tip 22 at the protrusion arm 10. Here, sound reception holes 211 and 221 are respectively formed in the upper and lower case frames 21 and 22, so that the microphone 30 can receive an external voice/sound. Also, a predetermined bushing 224 protrudes from an inner surface 223 of the lower case frame 22 to allow firm fixation of the microphone 30. Accordingly, the cable 40 electrically connected to the microphone 30 can extend from the mic tip 20, and passes through (i.e., penetrates) the protrusion arm 10 thus to be connected to the main body 110.

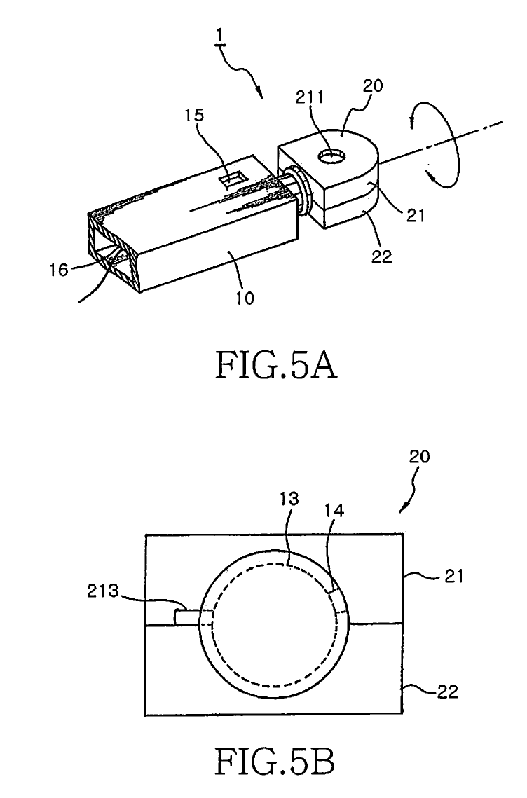

FIGS. 5A and 5B illustrate an operation of the mic tip 20 on the mic module 1 according to the present invention.

Since the mic tip 20 is rotatably installed at the protrusion arm 10, a rotation limiting unit is provided to prevent problems such as short-circuit due to cable twisting caused by unlimited rotation of the mic tip 20.

Referring also to FIG. 4, the rotation limiting unit includes a protrusion piece 14 protruding from an end portion 13 of the protrusion arm 10, and a stopping protrusion 213 formed on the upper case frame 21 or the lower case frame 22 and caught by the protrusion piece 14. However, as illustrated in FIG. 5B, since the stopping protrusion 213 and the protrusion piece 14 allow the mic tip 20 to rotate around 360 degrees, the rotating limiting unit does not degrade a voice reception function of the mic module 1.

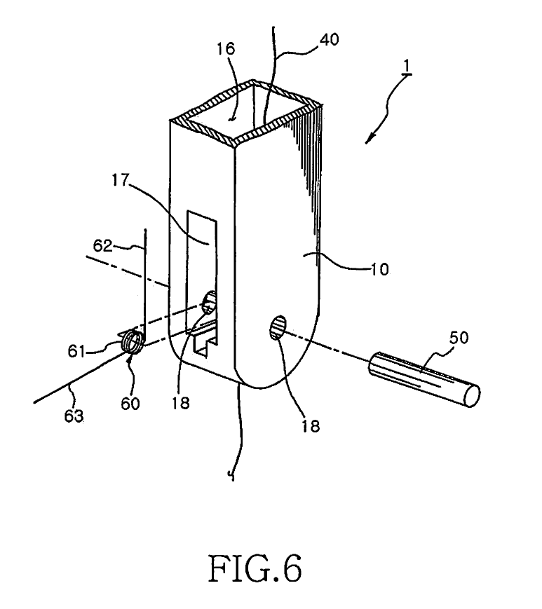

FIG. 6 is a perspective view illustrating a portion of the mic module 1 that is fixed to the portable terminal 100 according to the present invention. That is, the mic tip 20 is rotatably fixed to one end of the protrusion arm 10, and the other end of the protrusion arm 10 is fixed on the mounting groove 117 of the terminal 100, so that the protrusion arm 10 protrudes to the outside by manipulation of the mic button 72.

As illustrated in FIG. 6, a predetermined through hole 18 is formed at the other end of the protrusion arm 10. A hinge pin 50 penetrates the through hole 18 to serve as a hinge shaft allowing the mic module 1 to protrude outside the portable terminal 100 from the mounting groove 117. That is, the hinge pin 50 penetrates the protrusion arm 10, and has both ends that are respectively fixed to both ends of a frame of the mounting groove 117, thereby allowing the protrusion arm 10 to pivot on the hinge pin 50 without being separated.

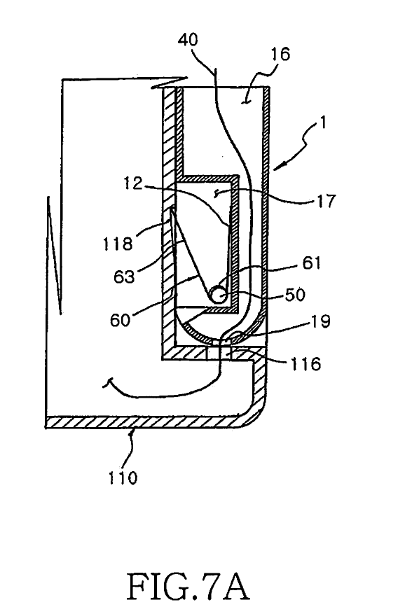

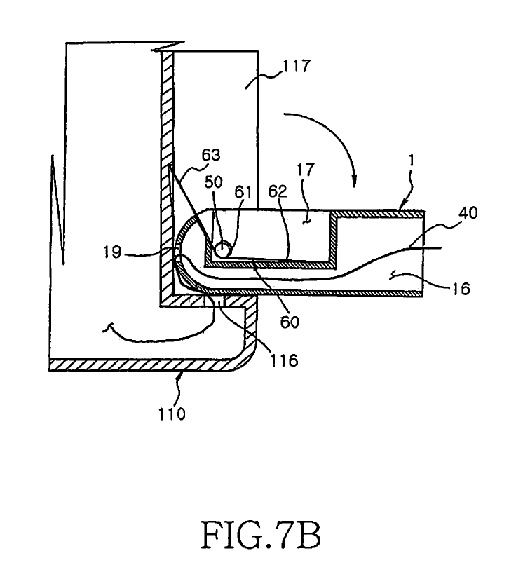

FIGS. 7A and 7B illustrate an operation of the mic module 1 according to the present invention. A predetermined pressing unit forces the protrusion arm 10 to the outside the portable terminal 100 from the mounting groove 117. A torsion spring 60 is used as the pressing unit. The torsion spring 60 may be inserted in a spring mounting groove 17 formed in an end portion of the protrusion arm 10, and be fixed by the hinge pin 50 penetrating the center 61 of the torsion spring 60. Also, one end 62 of the torsion spring 60 presses the protrusion arm 10 from the spring mounting groove 17, and the other end 63 of the torsion spring 60 is supported on an inner surface of the mounting groove 117 of the portable terminal 100. Accordingly, once a locking force applied to the protrusion arm 10 from a locking unit (to be described later) is released, the mic module 1 protrudes from the portable terminal 100 by a pressing force of the torsion spring 60 that is supported on the inner surface of the mounting groove 117 of the portable terminal 100 and presses the protrusion arm 10.

The cable 40 of the microphone 30, which penetrates the hollow portion 16 of the protrusion arm 10, passes through a cable through hole 19 formed in an end portion of the protrusion arm 10, and penetrates another cable through hole 116 formed in the mounting groove 117 of the portable terminal 100. Thus, the cable 40 is electrically connected to a main board (not shown) of the main body 110.

FIG. 8 is a sectional view illustrating a locking unit of the mic module 1 according to the present invention. Since the mic module 1 according to the present invention semi-automatically operates, the locking unit is provided in order to continuously maintain a received state of the mic module 1 within the mounting groove 117 of the portable terminal 100 and to control a pressing force of the torsion spring 60.

The locking unit includes a stopping groove 15 formed in a predetermined location of an external surface of the protrusion arm 10, and a lever 70 operated to be selectively caught by the stopping groove 15. The lever 70 is installed near the mounting groove 117 in the portable terminal 100. The lever 70 includes a predetermined pivot shaft 71. With reference to the predetermined pivot shaft 71, one end of the lever 70 is formed as a mic button 72 partially protruding from an outer surface of the portable terminal, and the other end of the lever 70 is formed as a locking portion 73 caught by the stopping groove 15 of the protrusion arm 10, and partially protrudes to the mounting groove 117. Of course, a spring 74 may be installed to support the mic button 72 so that the mic button 72 protrudes to the outside all the time. The locking portion 73 is formed in the form of a hook, and thus can be easily caught by the stopping groove 15 of the protrusion arm 10. Consequently, when the mic button 72 is pressed, the pivot shaft 71 rotates, the locking portion 73 separates from the stopping groove 15 by the principle of a lever, and the protrusion arm 10 protrudes to the outside by the construction illustrated in FIGS. 6 through 7B.

When a user forces the mic module 1 into the mounting groove 117 of the portable terminal 100, the locking portion 73 of the lever 70 which partially protrudes to the mounting groove 117 is caught by the stopping groove 15 formed in the outer surface of the protrusion arm 10 of the mic module 1, so that the mic module 1 does not protrude outside the portable terminal 100.

Although a hooking structure using the lever 70 and the spring 74 is used in the present invention, any well-known locking unit may be used, provided that it can continuously maintain a received state of the protrusion arm 10 within the mounting groove 17.

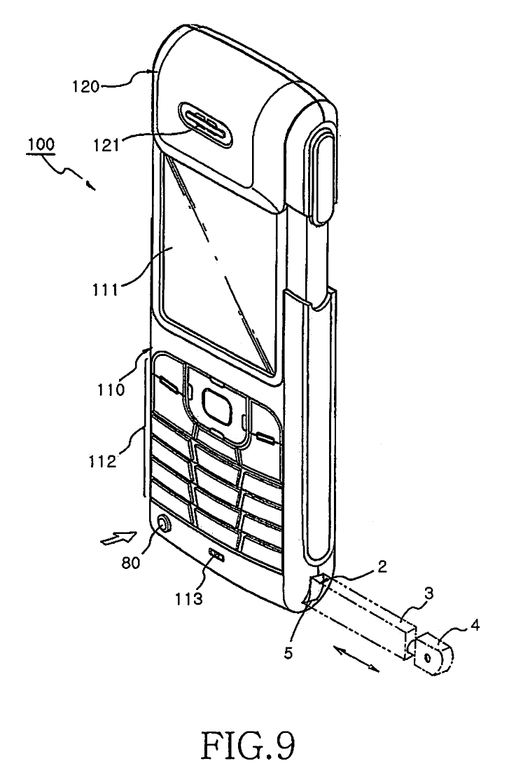

FIG. 9 is a front perspective view of a portable terminal with a mic module according to another embodiment of the present invention.

As illustrated in FIG. 9, a predetermined groove 5 is formed in a lower end of one side of the portable terminal. A mic module 2 is inserted in the groove 5 so as to move linearly. A protrusion arm 3 and a rotary mic tip 4 that are identical to those in the above description may be used. Like locking and pressing units according to the present invention may be used. Thus, the mic module 2 may slide into or out of the groove 5 by user's manipulation of mic button 80.

According to another embodiment of the present invention, when a terminal space is available, the mic module 2 may be inserted into a terminal, and then protrude linearly by the button manipulation, which is different from the method in which the mic module 1 according to one embodiment of the present invention pivots on one end thereof and protrudes outside the portable terminal. The main point of another embodiment of the present invention is whether the terminal space is available or not. Although the mic module protrudes from a lower portion of the terminal in a width direction of the terminal in the present invention, the present invention is not limited thereto. For example, the mic module may protrude from an upper portion of the terminal in a length direction thereof.

Also, although the mic module semi-automatically protrudes from the portable terminal in the present invention, the mic module may be manually protruded using the above protruding methods without using the locking unit and the pressing unit.

According to the present invention, the portable terminal includes the mic module that protrudes outside the terminal only when necessary and includes a rotatable end portion. Thus, an external voice/sound can be effectively recorded through the protruding mic module when a moving image is captured. When the mic module is not needed, the mic module does not protrude outside the terminal, thereby refining an exterior of a device, and improving convenience of use of the terminal.

While the invention has been shown and described with reference to certain preferred embodiments thereof, it will be understood by those skilled in the art that various changes in form and details may be made therein without departing from the spirit and scope of the invention as defined by the appended claims.

1. A portable terminal with a protrusion type mic module, comprising:
a camera module installed at a predetermined portion of the portable terminal; and
a mic module selectively protruding from the portable terminal for audio recording,
wherein the mic module comprises a protrusion arm having a predetermined length and a mic tip rotatably installed at a first end of the protrusion arm, the mic tip comprising a microphone and at least one sound reception hole.

2. The portable terminal of claim 1, wherein the mic tip further comprises a rotation limiting unit preventing the mic tip from rotating unlimitedly in one direction.

3. The portable terminal of claim 2, wherein the rotation limiting unit comprises:
a protrusion piece protruding from the first end of the protrusion arm; and
a stopping protrusion formed inside the mic tip, the stopping protrusion being caught by the protrusion piece when the mic tip rotates so as to prevent the mic tip from rotating beyond 360 degrees.

4. The portable terminal of claim 3, wherein the microphone is electrically connected to a cable having a predetermined length, and the cable passes through the protrusion arm being hollow and the mounting groove and thus is electrically connected to the portable terminal.

5. The portable terminal of claim 1, wherein the mic module is inserted in a mounting groove and selectively protrudes by manipulation of a user, the mounting groove being formed with a predetermined depth in a side of the terminal in a length direction.

6. The portable terminal of claim 5, wherein the mic module protrudes by pivoting at one end of the mic module and about a pivot axis perpendicular to a top surface of the portable terminal.

7. The portable terminal of claim 5, wherein the protrusion arm is rotatably installed to the mounting groove such that a hinge pin having a predetermined length passes through a second end of the protrusion arm.

8. The portable terminal of claim 7, wherein the mic module is constructed semi-automatically so as to be open by button manipulation of a user.

9. The portable terminal of claim 8, wherein the mic module further comprises:
a pressing unit forcing the protrusion arm to pivotably protrude from a received state of the protrusions arm; and
a locking unit storing a pressing force of the pressing unit when the protrusion arm is received in the mounting groove, the locking unit selectively maintaining the received state.

10. The portable terminal of claim 9, wherein the pressing unit is a torsion spring including a central portion installed at one of the mounting groove and the protrusion arm, wherein one end of the torsion spring is supported on the mounting groove, and an other end of the torsion spring forces the protrusion arm to pivotably protrude.

11. The portable terminal of claim 10, wherein the torsion spring is installed and fixed such that the hinge pin penetrating the protrusion arm passes through a central portion of the torsion spring.

12. The portable terminal of claim 9, wherein the locking unit includes one end formed as a mic button protruding from the portable terminal, and an other end formed as a locking portion partially protruding to the mounting groove, so that the locking portion is selectively caught by a stopping groove formed in an outer surface of the protrusion arm, wherein a central portion of the locking unit serves as a pivot shaft.

13. The portable terminal of claim 12, wherein the locking unit further comprises a spring that presses the locking unit to maintain the mic button protruding to an outside of the terminal, and the locking portion protruding to the mounting groove.

14. The portable terminal of claim 12, wherein the locking portion is formed into a hook type in order to be smoothly caught by the stopping groove.

15. The portable terminal of claim 1, wherein the mic module is inserted into a predetermined portion of the terminal, the mic module selectively protruding by sliding out of the terminal by a user's manipulation.

16. The portable terminal of claim 15, wherein the mic module comprises:
a protrusion arm having a predetermined length; and
a mic tip rotatably installed at the first end of the protrusion arm, and comprising a microphone and at least one sound reception hole.

17. The portable terminal of claim 16, wherein the microphone is electrically connected to a cable having a predetermined length,
wherein the cable penetrates the protrusion arm being hollow to be electrically connected to the portable terminal.
